(19) United States
(12) Patent Application Publication
(10) Pub. No.: US 2007/0063486 A1
(43) Pub. Date: Mar. 22, 2007

(54) Pick-up trolley

(76) Inventor: Tai-Lang Lin, Rende Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/230,659

(22) Filed: Sep. 21, 2005

(51) Int. Cl. B62B 1/00

(52) U.S. Cl. 280/651

(57) ABSTRACT

A pick-up trolley includes an upper deck and a lower deck which includes casters connected to an underside thereof and two support links are pivotably connected to the two decks. A ladder is connected between the two support links and includes two side rails and steps connected between the side rails. Each side rail has a compressible section and two stop retaining members are connected beneath the two respective compressible sections. When a user steps on any of the steps, the load of the user compresses the compressible sections so that the lower ends of the side rails are lowered to contact the floor to automatically brake the trolley.

### FIELD OF THE INVENTION

The present invention relates to a pick-up trolley which includes a automatic brake feature and can be foldable.

### BACKGROUND OF THE INVENTION

A conventional pick-up trolley generally includes an upper deck and a lower deck connected by upright links, the lower deck includes casters connected to an underside thereof. A ladder device is connected to the two decks and includes two side rails with steps connected therebetween. The user may roll the pick-up trolley by the casters to a desired position and then climate on the ladder to put parts on the shelves or pick parts from the shelves and put them on the decks. It is noted that the conventional pick-up trolley does not have brake feature so that when the user climates on the ladder, the pick-up trolley is in an unstable status which could lead to a dangerous result. In addition, the conventional pick-up trolley cannot be foldable because all of the links, the decks and the ladder are soldered with each other so that it occupies a lot of space.

The present invention intends to provide a foldable pick-up trolley which includes a brake feature so that when a user climates on the ladder, the ladder is automatically contacts against the floor to brake the trolley.

### SUMMARY OF THE INVENTION

The present invention relates to a pick-up trolley that comprises an upper deck and a lower deck which includes casters connected to an underside thereof. Two support links are pivotably connected to two decks. A ladder is connected between the two support links and includes two side rails and steps connected between the side rails. Each side rail has a compressible section and two stop retaining members are connected beneath the two respective compressible sections of the two side rails. The compressible sections are compressible against the stop members and the side rails can be freely movable through the stop members so as to contact the floor to brake the trolley.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the pick-up trolley of the present invention;

FIG. 2 is a perspective view to show the pick-up trolley of the present invention;

FIG. 3 shows a side view of the pick-up trolley of the present invention;

FIG. 4 shows that the side rails contact the floor when the user steps on the ladder;

FIG. 5 shows that the support links are pivotable about the lower deck, and

FIG. 6 shows that the upper deck is pivotable relative to the support links.

### DETAILED DESCRIPTION OF THE PREFERRED EMBODIMENT

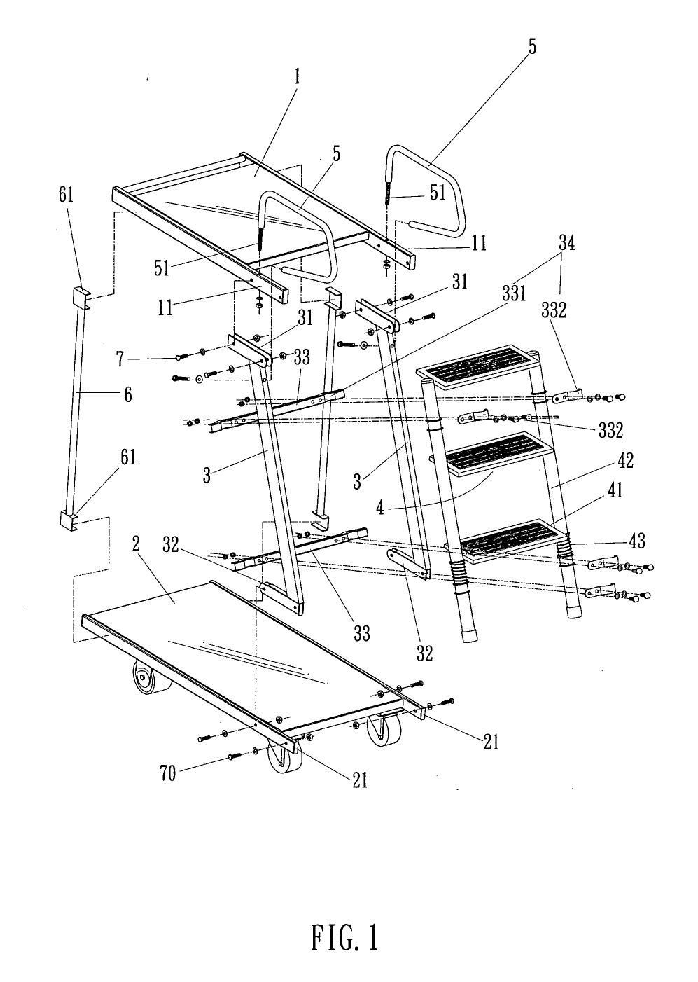

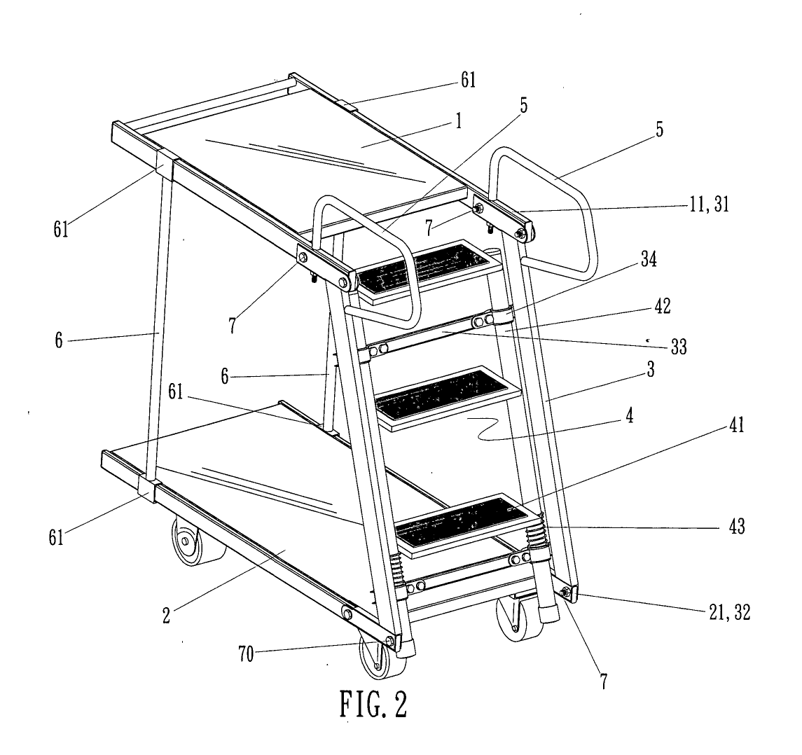

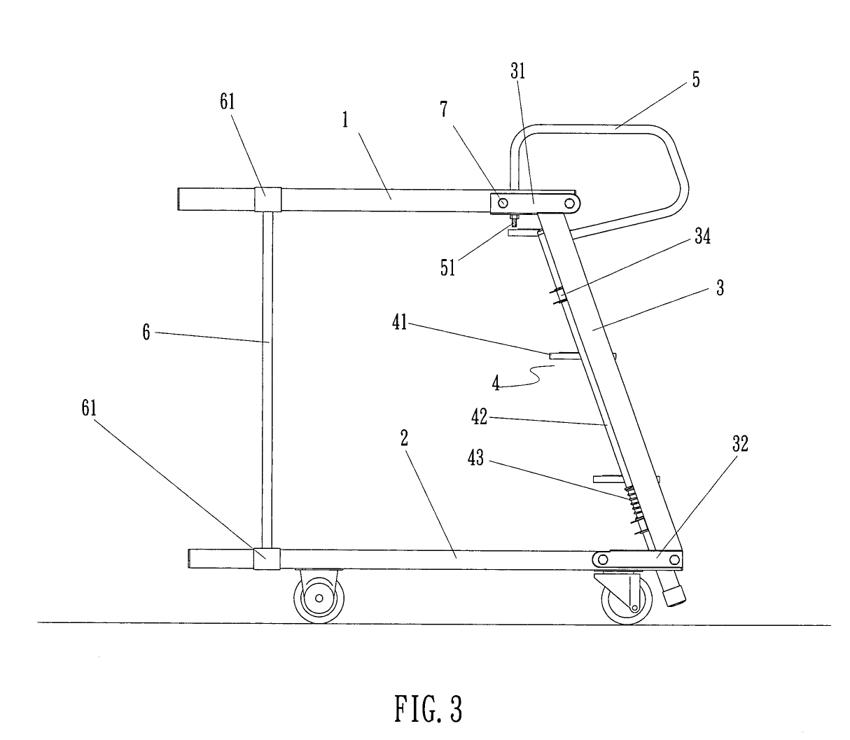

Referring to FIGS. 1 to 3, the pick-up trolley of the present invention comprises an upper deck 1 and a lower deck 2 which includes casters connected to an underside thereof. Two support links 3 are pivotably connected to two respective first ends of the upper deck 1 and the lower deck 2, and two reinforcement links 6 are connected between two respective second ends of the upper deck 1 and the lower deck 2. Each of the reinforcement links 6 includes two U-shaped frames 61 on two ends thereof and the U-shaped frames 61 are mounted to two sides of the upper deck 1 and the lower deck 2.

The upper deck 1 includes two first connection ends 11 extending from the first end thereof and the lower deck 2 includes two second connection ends 11 extending from the first end thereof. Each of the two support links 3 has two upper connection ends 31 which are pivotably connected to the first connection ends 11 on the upper deck 1 by bolts 7, and two lower connection ends 32 which are pivotably connected to the second connection ends 21 by bolts 70. Two handles 5 each have a threaded end 51 which is connected to the first connection ends 11 on the upper deck 1 and the other end of each of the two handles 5 is connected to the support link 3 corresponding thereto.

Two bars 33 are connected between the two support links 3 and a ladder 4 is connected between the two support links 3 and positioned by two stop members 34 on the bars 33. The ladder 4 includes two side rails 42 and three steps 41 are connected between the side rails 42. Each side rail 42 has a compressible section 43 and the two stop retaining members 34 are respectively connected beneath the two respective compressible sections 43 of the two side rails 42. The stop members 34 each are composed of a recess 331 defined in each of the bars 33 and a retaining plate 332. The side rails 42 are respectively engaged with the two recesses 331 and retained by the retaining plates 332 mounted on the two side rails 42. The lower ends of the two side rails 42 are normally located above the floor a distance when no load is on the ladder 4.

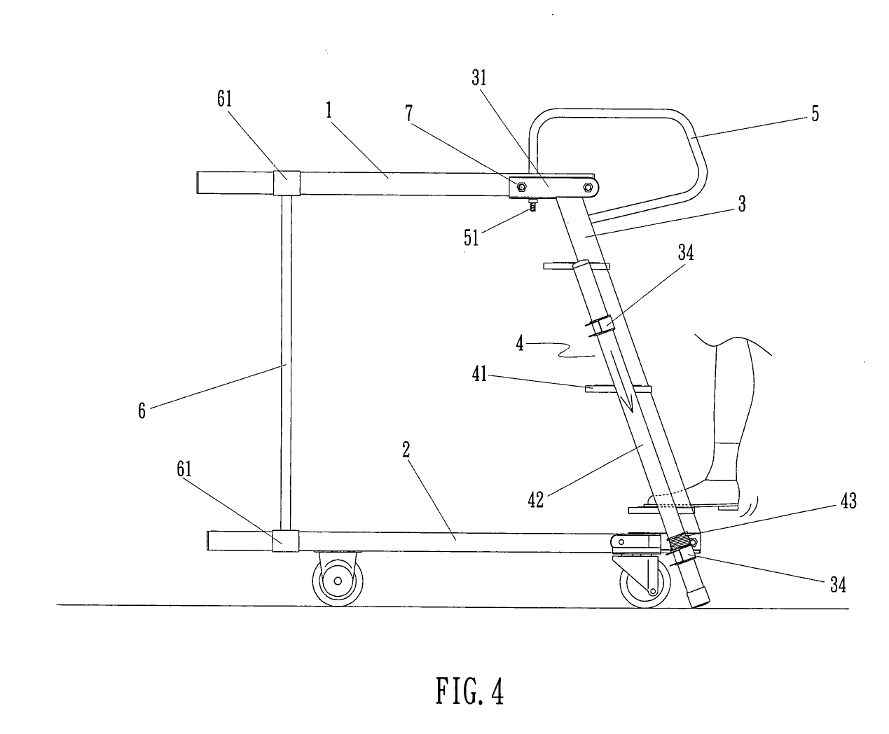

As shown in FIG. 4, when the user steps on any of the steps 41 of the ladder 4, the load moves the side rails 42 downward and the side rails 42 being freely movable through the stop members 34 so that the compressible sections 43 are compressible against the stop members 34 and the lower ends of the side rails 42 are in contact with the floor to automatically brake the trolley.

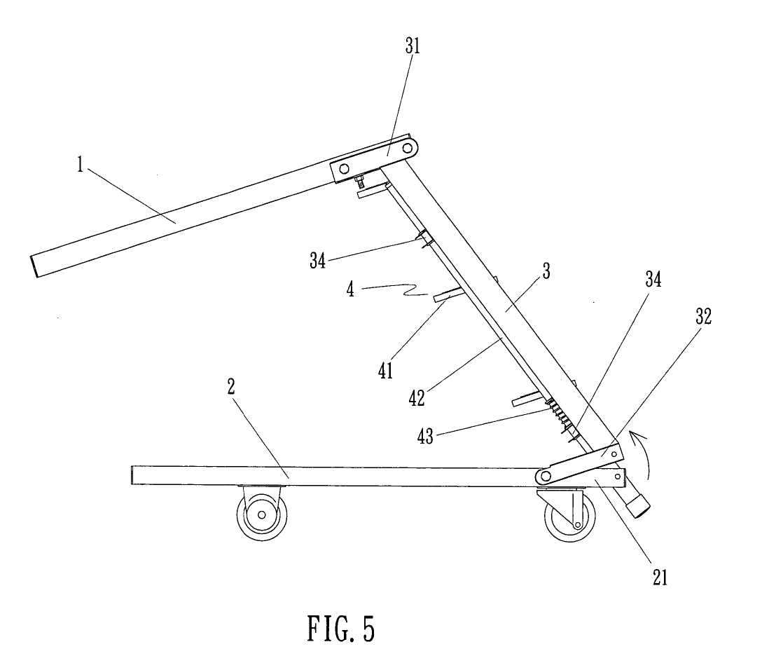

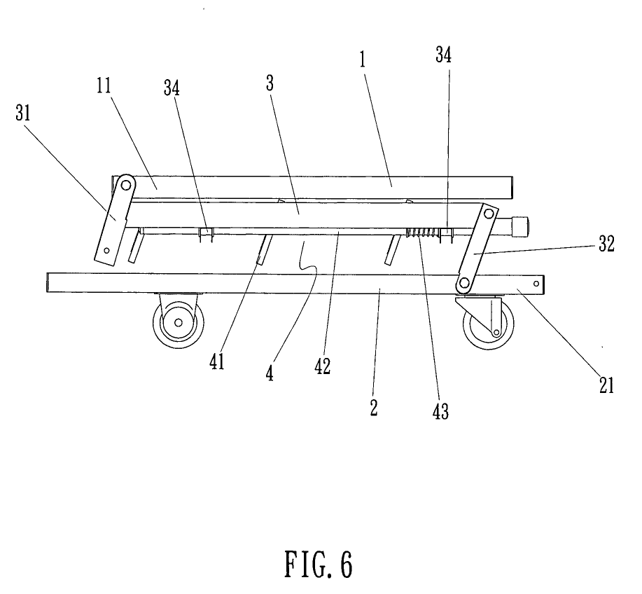

As disclosed in FIG. 5, when folding the support links 3 together with ladder 4, the lower connection ends 32 of the support links 3 can be pivoted about the second connection ends 21. The upper deck 1 is then pivoted toward the lower deck 2 to fold the trolley as shown in FIG. 6.

While we have shown and described the embodiment in accordance with the present invention, it should be clear to those skilled in the art that further embodiments may be made without departing from the scope of the present invention.

What is claimed is:

1. A pick-up trolley comprising:
an upper deck and a lower deck, casters connected to an underside of the lower deck, two support links pivotably connected to two respective first ends of the upper deck and the lower deck, and
a ladder connected between the two support links and including two side rails and steps connected between the side rails, each side rail having a compressible section and two stop retaining members connected beneath the two respective compressible sections of the two side rails, the compressible sections being compressible against the stop members and the side rails being freely movable through the stop members.

2. The trolley as claimed in claim 1, wherein at least one bar is connected between the two support links and the stop members each are composed of a recess defined in the at least one bar and a retaining plate, the side rails are respectively engaged with the two recesses and retained by the retaining plates mounted on the two side rails.

3. The trolley as claimed in claim 1, wherein the upper deck includes two first connection ends extending from the first end thereof and the lower deck includes two second connection ends extending from the first end thereof, each of the two support links has two upper connection ends and two lower connection ends, the first connection ends on the upper deck are pivotably connected to the upper connection ends by bolts and the second connection ends are pivotably connected to the lower connection ends by bolts.

4. The trolley as claimed in claim 1, wherein two reinforcement links are connected between two respective second ends of the upper deck and the lower deck.

5. The trolley as claimed in claim 4, wherein each of the reinforcement links includes two U-shaped frames on two ends thereof and the U-shaped frames are mounted to two sides of the upper deck and the lower deck.

6. The trolley as claimed in claim 3, wherein two handles each have a threaded end which is connected to the first connection ends on the upper deck and the other end of each of the two handles is connected to the support link corresponding thereto.
